(19) United States
(12) Patent Application Publication
(10) Pub. No.: US 2017/0083461 A1
(43) Pub. Date: Mar. 23, 2017

(54) INTEGRATED CIRCUIT WITH LOW LATENCY AND HIGH DENSITY ROUTING BETWEEN A MEMORY CONTROLLER DIGITAL CORE AND I/OS

(71) Applicant: QUALCOMM Incorporated, San Diego, CA (US)

(72) Inventors: Kunal Desai, Bangalore (IN); Aniket Aphale, Bangalore (IN); Umesh Rao, Bangalore (IN)

(21) Appl. No.: 14/861,114

(22) Filed: Sep. 22, 2015

(51) Int. Cl. G06F 13/16; G06F 13/40; G06F 3/06

(52) U.S. Cl. CPC G06F 13/1673; G06F 3/0611; G06F 3/0629; G06F 3/0673; G06F 13/1689; G06F 13/4068

(57) ABSTRACT

An integrated circuit is provided with a memory controller coupled to a buffered command and address bus and a pipelined data bus having a pipeline delay. The memory controller is configured to control the write and read operations for an external memory having a write latency period requirement. The memory controller is further configured to launch write data into the pipelined data bus responsive to the expiration of a modified write latency period that is shorter than the write latency period.

### TECHNICAL FIELD

This application relates to memories, and more particularly to a memory controller and its routing to a plurality of distributed endpoints.

### BACKGROUND

A memory controller for external dynamic random access memory (DRAM) must meet certain strict timing relationships as required, for example, under the Joint Electron Device Engineering Council (JEDEC) standards. For example, the memory controller must satisfy the write latency (WL) requirement between the write data (DQ) to be written to the DRAM and the corresponding command and address (CA) signals. In other words, a DRAM cannot receive the write data in the same memory clock cycle over which the DRAM receives a write command. Instead, the write data is presented the write latency number of clock cycles after the presentation of the write command. With regard to enforcing the write latency, the memory controller digital core interfaces to the corresponding DRAM(s) through input/output (I/O) circuits that may also be designated as endpoints or endpoint circuits.

In applications such as for a personal computer (PC), the routing between the memory controller and its endpoints is relatively simple. In that regard, a PC microprocessor integrated circuit is mounted onto a motherboard that also supports various other integrated circuits such as those required for networking, graphics processing, and so on. A series of dynamic random memory (DRAM) integrated circuits are also mounted onto the motherboard and accessed through a motherboard memory slot. The memory controller for the DRAMs is typically located within a memory controller integrated circuit that couples between the microprocessor bus and the DRAMs. The PC memory controller and its endpoints are relatively co-located within the memory controller integrated circuit, which simplifies routing the CA signals and the DQ signals to the endpoints with the proper signal integrity. Should the memory controller instead be integrated with the microprocessor, the memory controller may still be relatively co-located with the corresponding endpoints such that routing issues between the memory controller and the endpoints are mitigated.

But the memory controller design is quite different for a system on a chip (SoC) integrated circuit such as developed for the burgeoning smartphone/wearable market in which a package-on-package (PoP) LPDDR DRAM configuration is used for many products. In such PoPs, different DRAM pins may need to be accessed from different sides of the SoC. The memory controller in an SoC is thus located relatively far from the endpoints. Thus the endpoints (I/O circuits) are located on the periphery of the SoC die. In contrast, the memory controller is located more centrally within the SoC die so that the trace lengths for the buses from the memory controller to the various endpoints may be more readily matched. The CA and DQ signals from an SoC memory controller must thus traverse relatively long propagation paths over the corresponding buses from the SoC memory controller to the endpoints. Should metal traces alone be used to form these relatively-long propagation paths across the SoC die, the CA and DQ signals would be subject to significant propagation losses, delay, and noise. It is thus conventional to insert a plurality of buffers into the CA and DQ buses the memory controller to the endpoints. The buffers boost the CA and DQ signals and thus address the losses and noise. In addition, the propagation delay along a metal trace is proportional to a product of its capacitance and resistance. Both these factors will tend to linearly increase as the propagation path length is extended such that the propagation delay becomes quadratically proportional to the path length. The shorter paths between the consecutive buffers on the buffered buses thus reduces the propagation delay that would otherwise occur across an un-buffered path having the same length as a buffered bus. Since the buses carry high-frequency signals with tight timing requirements, the metal traces are typically subject to non-default routing (NDR) rules to minimize propagation delay, signal deterioration, and crosstalk. The NDR rules specify a larger wire width, larger spacing, and also shielding wires running in parallel with the signal wires to mitigate crosstalk and related issues. The resulting NDR routing between the memory controller and its endpoints in a conventional SoC demands significant area usage and complicates the routing of other signals.

As an alternative to the use of buffers buses and NDR routing, the CA and DQ buses may each be pipelined using a series of registers. The resulting routing for the pipelined paths need no longer follow NDR rules and is thus more compact as compared to the buffered routing approach. But the registers add a significant pipeline delay to each path. For example, if the CA and DQ bus is each pipelined with eight registers, it may require four clock cycles to drive a CA or DQ signal from memory controller to an endpoint (assuming half the registers are clocked with the rising clock edges and half are clocked with the falling clock edges). But the CA bus carries both the read and the write commands. The SoC processor and other execution engines will thus be undesirably subjected to the pipeline delays every time it issues a read command. The increased delay for read data can negatively affect the performance of the various execution engines in the SoC. An SoC designer is then forced to choose between the area demands of bulky buffered CA and DQ buses or the increased delay of pipelined CA and DQ buses.

Accordingly, there is a need in the art for improved memory controller architectures for system on a chip applications such as used in PoP packages.

### SUMMARY

To improve density without suffering from increased delay, an integrated circuit is provided with a memory controller that drives a command and address (CA) write signal over a buffered CA bus and that drives a data (DQ) signal over a pipelined DQ bus. Since the buffered CA bus is not pipelined, it will be received at a CA endpoint circuit in the same memory clock cycle as when the write signal was launched from the memory controller. In contrast, the pipelined DQ bus has a pipeline delay corresponding to P cycles of the clock signal such that the DQ signal will be received at a DQ endpoint circuit P clock cycles after it was launched by the memory controller (P being a positive integer). In turn, the DQ endpoint circuit will launch the received DQ signal to an external memory having a write latency (WL) period requirement that equals WL clock cycles (WL also being a positive integer). To assure that the write latency period requirement is satisfied at the external memory, the memory controller is configured to launch the DQ signal a modified write latency period after the launching of the write command, where the modified write latency period equals (WL-P) clock cycles.

The resulting integrated circuit is relatively compact. In addition, a processor in the integrated circuit may issue read and write commands without suffering from the delays of a pipelined architecture. These and other advantageous features may be better appreciated through the following detailed description.

### BRIEF DESCRIPTION OF THE DRAWINGS

FIG. 1A is a diagram of an SoC including a memory controller configured to drive a buffered CA bus and pipelined DQ buses in accordance with an aspect of the disclosure.

FIG. 1B is a diagram of an SoC including a memory controller configured to drive a buffered CA bus and DQ buses having an adaptive pipelining delay in accordance with an aspect of the disclosure.

FIG. 2 is a diagram of a system including an SoC having a memory controller configured to drive a buffered CA bus and pipelined DQ buses to drive an external DRAM accordance with an aspect of the disclosure

FIG. 3 is a timing diagram for the write command and the write data for the system of FIG. 2.

FIG. 4 is a flowchart for an example method of operation in accordance with an aspect of the disclosure.

The various aspects of the present disclosure and their advantages are best understood by referring to the detailed description that follows. It should be appreciated that like reference numerals are used to identify like elements illustrated in one or more of the figures.

### DETAILED DESCRIPTION

To increase density and operating speed, a memory controller is provided in which the command and address (CA) bus between the memory controller and its endpoints is buffered whereas the data (DQ) buses between the memory controller and its endpoints are pipelined with registers. Since there may be only one buffered CA bus for a relatively large number of pipelined DQ paths, the area demands from any non-default routing rules (NDR) routing of the metal traces for the buffered CA bus is minimal. In addition, the buffered CA bus increases memory operating speed. Since the data signals carried on the DQ buses will now be delayed by the clock cycles corresponding to the number of pipeline registers in each DQ bus whereas the CA signals will be unhindered by any pipelining, the write latency between the generation of the CA signals and the generation DQ signals within the memory controller is decoupled. In particular, the memory controllers disclosed herein launch their DQ signals with regard to a modified write latency that is shorter than the write latency required by the external memory.

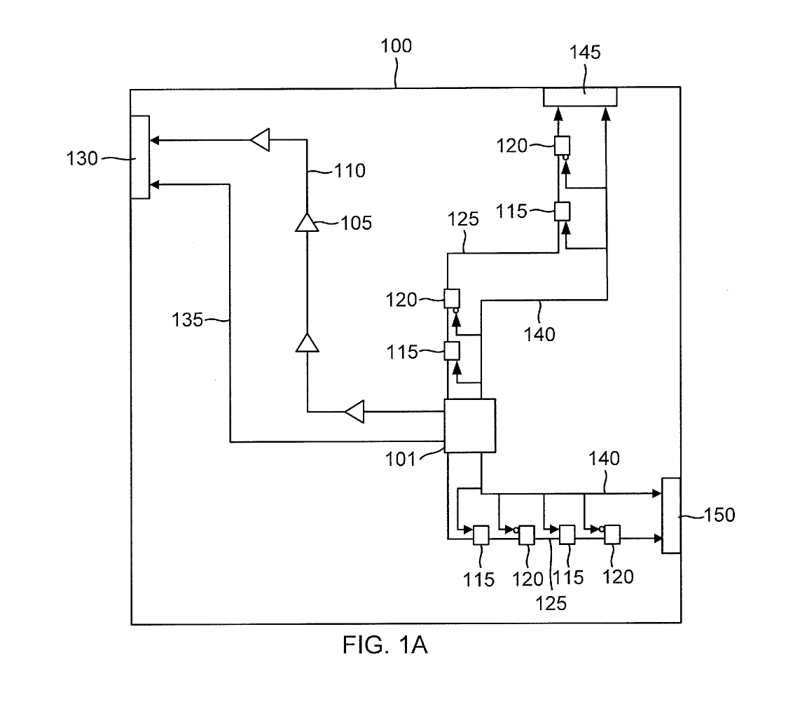

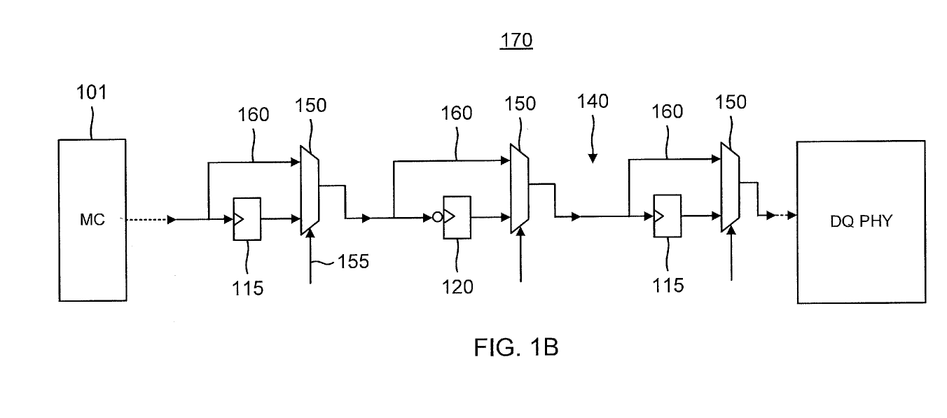

An example system-on-a-chip (SoC) 100 including a memory controller 101 is shown in FIG. 1A. Memory controller 101 drives the CA signals over a buffered CA bus 110 that includes a plurality of buffers 105. A CA endpoint 130 (which may also be denoted as an endpoint circuit) receives the CA signals on buffered CA bus 110 and performs the physical layer (PHY) processing of them prior to transmitting them to an external DRAM (not illustrated). It will be appreciated that buffered CA bus 110 is shown in simplified form as a single wire, in that the CA signals are multi-bit words. Buffered CA bus 110 thus comprises a plurality of metal traces (not illustrated), wherein the plurality of metal traces depends upon the width of the CA words. For example, if the CA words are 8-bit words, buffered CA bus 110 may comprise eight metal traces. In general, if the CA words are n-bit words, buffered CA bus 110 may comprise n metal traces, where n is a plural positive integer. Each buffer 105 thus represents a plurality of buffers corresponding to the plurality of metal layer traces. The metal layer traces may be routed according to non-default routing rules and shielded. Such a shielded and NDR routing for buffered CA bus 110 may also be denoted as a “super buffer” implementation. In one implementation, CA bus 110 may be deemed to comprise a means for propagating a write command signal from the memory controller 101 to CA endpoint 130 without a pipeline delay.

In addition, memory controller 101 drives a plurality of pipelined data (DQ) buses 125 that are received by a corresponding plurality of DQ endpoints 145. Each pipelined DQ bus 125 includes a plurality of pipeline registers that are clocked by the memory write clock distributed by memory controller 101 to DQ endpoints 145. The corresponding clock paths and clock source are not shown for illustration clarity. Each DQ bus 125 may be deemed to comprise a means for propagating a DQ signal from the memory controller 101 to a DQ endpoint 145 with a pipeline delay. The pipeline registers may alternate as rising-edge clocked registers 115 and falling-edge clocked registers 120. The delay between a consecutive pair of registers 115 and 120 thus corresponds to one half cycle of the memory clock signal. The total delay in clock cycles across each pipeline DQ bus 125 thus depends upon how many pipeline stages formed by pairs of registers 115 and 120 are included. For example, if there six registers 115 (and thus six registers 120) included in each pipelined DQ bus 125, the total pipeline delay in clock cycles for the DQ signals to propagate from memory controller 101 to the corresponding DQ endpoint 145 would be six clock cycles. In alternative implementations, pipelined DQ bus 125 may be responsive to just one clock edge (rising or falling) such that its registers would be all rising-edge triggered or all falling-edge triggered. As will be explained further herein, memory controller 101 is configured to use this pipeline delay with regard to launching the DQ data signals with respect to a modified or pseudo write latency period. For example, if the pipelining delay is six clock cycles whereas the desired write latency is eight clock cycles, memory controller 101 may launch the DQ signals two clock cycles after the launch of the corresponding write command. More generally, the pipelining delay may be represented by a variable P whereas the write latency required by the external memory may be represented as the variable WL (both delays being some integer number of clock cycles). The memory controller may thus launch the DQ signals by the difference between the write latency and the pipelining delay (WL-P) in clock cycles after the launch of the corresponding write command. The write command is subjected to no pipelining delay on buffered CA bus 110 such that it arrives at CA endpoint 130 in the same clock cycle as when it was launched. In contrast, the DQ signals will be delayed by the pipelining delay. Since the DQ signals were launched WL-P clock cycles after the write command, the DQ signals thus arrive at their DQ endpoints 145 by a delay of WL−P+P=WL in clock cycles after the launch of the CA write command. The desired write latency is thus maintained despite the lack of pipelining for the CA write command.

Note that the required write latency for DRAMs such as specified by the JEDEC specification may depend upon the clock rate. The clock rate may be changed depending upon the mode of operation. For example, the clock rate may be slowed down in a low power mode of operation as compared to the rate used in a high performance mode of operation. In that regard, the JEDEC specification requires a write latency of eight clock cycles at a clock rate of 988 MHz but reduces the required write latency to be just three clock cycles at a clock rate of 400 MHz. The resulting change in clock rate may thus result in the changed write latency being less than the pipelining delay for each DQ bus 125. For example, if the pipelining delay was six clock cycles but the new value for the write latency was three clock cycles, memory controller 101 could not satisfy the required write latency even if it launched the DQ data signals in the same clock cycle as it launched the corresponding CA write command.

To account for any changing of the write latency such as with regard to modes of operation, each pipelined DQ bus 125 in system 100 may be replaced by an adaptive pipelined DQ bus 140 as shown in FIG. 1B to provide an adaptive pipelining delay in an SoC 170. Just one adaptive pipelined DQ bus 140 coupled between a memory controller 175 and a corresponding DQ endpoint 145 is shown in FIG. 1B for illustration clarity. Similarly, buffered CA bus 110 is not shown in FIG. 1B for additional illustration clarity. Adaptive pipelined DQ bus 140 includes pipeline stages formed by pairs of a rising-edge clocked register 115 and a falling-edge clocked register 120 analogously as described with regard to pipelined DQ bus 125. To provide an adaptive pipeline delay, each register 115 in adaptive pipelined DQ bus 140 may be bypassed by a corresponding multiplexer 150. The DQ input to each register 115 may thus shunt past the register on a bypass path 160 to the corresponding multiplexer 150. Similarly, each register 120 may be bypassed through a corresponding bypass path 160 to a corresponding multiplexer 150. If a multiplexer 150 is controlled to select for its bypass path 160 input, the corresponding register 120 or 115 is bypassed. Conversely, if a multiplexer selects for a Q output from its corresponding register 120 or 115, a half-cycle of pipelining delay is added to DQ bus 140 accordingly. Memory controller 175 is configured to control multiplexers 150 through corresponding control signals 155 so that adaptive pipelined DQ bus 140 has the appropriate pipeline delay for a given value of the write latency.

Note that each DQ signal carried on a corresponding pipelined DQ bus 125 or 140 is a multi-bit word just like the corresponding CA write command. Each pipelined DQ bus 125 or 140 may thus comprise a plurality of metal layer traces corresponding to the width in bits of the DQ signals they carry. These individual traces are not shown for illustration clarity. Registers 115 and 120 would thus comprises a plurality of such registers for each individual bit in the corresponding DQ signal.

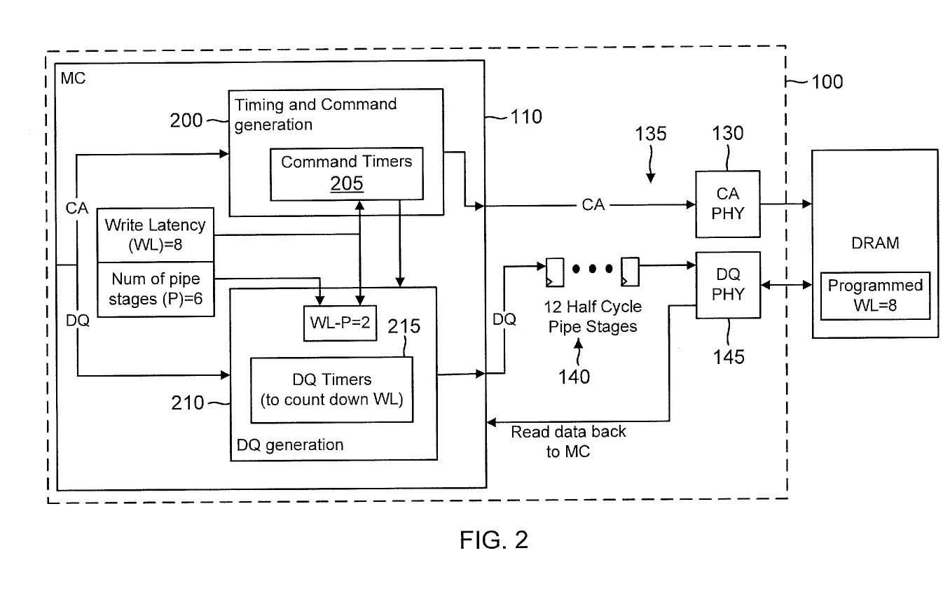

A more detailed view of SoC 100 is shown in FIG. 2 in combination with an external DRAM 220 having a write latency (WL) period requirement of eight clock cycles. Given this WL requirement, DRAM 220 must receive the DQ signals for a given write operation from DQ endpoints 145 eight clock cycles after receiving the corresponding CA write command from CA endpoint 130. This write latency is satisfied despite the pipelining of DQ buses 125 and the lack of pipelining for CA bus 110 because memory controller 101 accounts for the delay difference period between the required write latency and the pipeline delay across each DQ bus 125. In SoC 100, the pipeline delay (P) is six clock cycles as each pipelined DQ bus 125 includes twelve half-cycle pipeline stages (registers 115 and 120 discussed with regard to FIG. 1A). It will be appreciated that the pipeline delay for alternative implementations may be greater than or less than this example of six clock cycles. Memory controller 101 generates the write command (and other commands such as read commands) in a timing and command generation circuit 200 that includes command timers 205 for timing command delays such as turnaround delays in a conventional fashion with regard to the required write latency (WL). Timing and command generation circuit 200 drives the generated CA write command onto buffered CA bus 110 so that the commands may be received at CA endpoint 130 and driven to DRAM 220 accordingly. Timing and command generation circuit 200 may comprise a plurality of logic gates such as to implement a finite state machine configured to perform the necessary CA generation and timing functions.

A DQ generation circuit 210 is configured to calculate the delay difference between the write latency and the pipeline delay, which in this example would be two clock cycles. This delay difference may be considered to be a “modified write latency period” in that DQ generation circuit launches the DQ signals responsive to the expiration of the delay difference period analogously to how a conventional memory controller would launch its DQ signals at the expiration of the write latency period following the launch of the write command. DQ timers 215 are configured accordingly to time this two clock cycle difference so that DQ generation circuit 210 launches the corresponding DQ signals two clock cycles after timing and command generation circuit 200 launched the write command. DQ generation circuit 210 may comprise a plurality of logic gates such as to implement a finite state machine configured to perform the necessary DQ generation and timing functions. The write latency between the CA generation (in this example, eight clock cycles) and the modified write latency with regard to the DQ generation (in this example, two clock cycles) is thus decoupled. Although DQ buses 125 are pipelined, note that the read data buses from DQ endpoints 145 to memory controller 101 may be buffered so as to minimize the read latency. DQ generation circuit 210 may be considered to comprise a means for determining a delay difference period between a write latency period for an external memory and the pipeline delay and for driving the DQ signal into DQ bus 125 upon the expiration of the delay difference period.

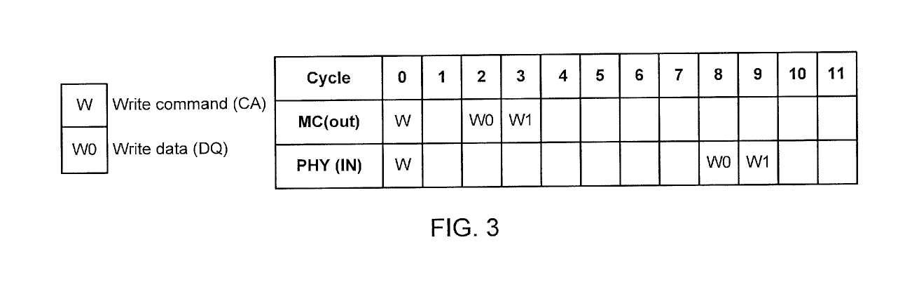

The resulting latency between the launching of the CA write command and the write data (DQ) is shown in tabular form in FIG. 3 for consecutive clock cycles 0 through 11. In clock cycle 0, the CA write command (W) is launched from the memory controller and received at the corresponding CA endpoint (PHY(IN)). The write data (WO) is then launched from the memory controller in clock cycle 2 as discussed with regard to FIG. 2. Due to the pipeline delay on the corresponding DQ bus, write data WO is not received at the corresponding endpoint until clock cycle 8, such that the desired write latency of eight clock cycles is satisfied.

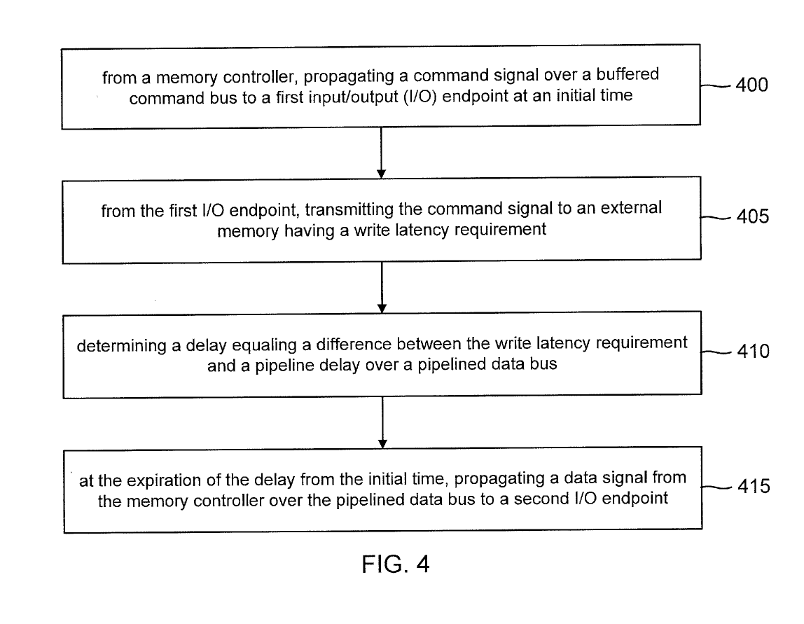

A method of operation will now be discussed with regard to the flowchart shown in FIG. 4. The method includes an act 400 of driving a command signal from a memory controller over a buffered command bus to a first input/output (I/O) endpoint at an initial time. The launching of a CA write command from memory controller 110 over buffered CA bus 110 to CA endpoint 130 is an example of act 400. The method further includes an act 405 of determining a delay difference equaling a difference between a write latency requirement for an external memory and a pipeline delay over a pipelined data bus, The calculation of the delay difference (WL-P) in DQ generation circuit 210 is an example of act 405. Finally, the method includes an act 410 that is responsive to the expiration of the delay difference subsequent to the initial time and comprises driving a data signal from the memory controller over the pipelined data bus to a second I/O endpoint. The launching of the DQ signal by DQ generation circuit 210 upon the expiration of the modified write latency period (WL-P) following the launching of the write command is an example of act 410.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

We claim:

1. An integrated circuit, comprising:
a buffered command and address (CA) bus;
a pipelined data (DQ) write bus having a pipeline delay; and
a memory controller configured to drive a write command signal into the buffered CA bus at an initial time, wherein the memory controller is further configured to determine a delay difference period between a write latency requirement for an external memory and the pipeline delay and to drive a DQ signal into the pipelined DQ write bus at an expiration of the delay difference period.

2. The integrated circuit of claim 1, further comprising a plurality of DQ endpoints, wherein the pipelined DQ write bus comprises a plurality of pipelined DQ write buses corresponding to the plurality of DQ endpoints, each pipelined DQ write bus being coupled between the memory controller and the corresponding DQ endpoint, and wherein the DQ signal comprises a plurality of DQ signals corresponding to the plurality of DQ endpoints, each DQ endpoint being configured to drive the corresponding DQ signal to an external memory.

3. The integrated circuit of claim 2, wherein the external memory is a dynamic random access memory (DRAM).

4. The integrated circuit of claim 2, further comprising a buffered DQ read bus coupled between the DQ endpoint and the memory controller.

5. The integrated circuit of claim 1, wherein the buffered CA bus comprises a plurality of buffers coupled to a plurality of metal-layer traces routed according to non-default routing rules.

6. The integrated circuit of claim 1, further comprising:
a clock source configured to provide a memory clock signal, wherein the memory controller is configured to drive the write command into the buffered CA bus at the initial time responsive to a first cycle of the memory clock signal, and wherein the memory controller is further configured to drive the DQ signal into the pipelined DQ write bus at the expiration of the delay difference period responsive to a second cycle of the memory clock signal.

7. The integrated circuit of claim 6, wherein the pipelined DQ write bus comprises a plurality of first registers and a plurality of second registers, and wherein the first registers are configured to be clocked by a rising edge of the memory clock signal, and wherein the second registers are configured to be clocked by a falling edge of the memory clock signal.

8. The integrated circuit of claim 6, wherein the pipelined DQ write bus comprises a plurality of registers and a plurality of corresponding multiplexers, wherein each multiplexer is configured to select for an output signal from the corresponding register and for a bypass path that bypasses the corresponding register, and wherein the memory controller is configured to control the selection by the multiplexers to adjust the pipeline delay.

9. The integrated circuit of claim 6, wherein the pipeline delay equals an integer P number of the memory clock cycles, and wherein the write latency requirement equals an integer number WL of the memory clock cycles, and wherein the delay difference period equals a difference between WL and P.

10. The integrated circuit of claim 6, wherein the memory controller includes a DQ timer configured to time the difference delay period responsive to being clocked with the memory clock.

11. The integrated circuit of claim 1, wherein, the memory controller is configured to adjust the pipeline delay for the pipelined DQ write bus responsive to a change in the write latency requirement.

12. A method, comprising:
from a memory controller, driving a command signal over a buffered command bus to a first input/output (I/O) endpoint at an initial time;
determining a delay equaling a difference between a write latency requirement for an external memory and a pipeline delay over a pipelined data bus; and
at the expiration of the delay from the initial time, driving a data signal from the memory controller over the pipelined data bus to a second I/O endpoint.

13. The method of claim 12, further comprising driving a clock signal from the memory controller to the second I/O endpoint, the method further comprising latching the data signal at the second I/O endpoint responsive to the clock signal.

14. The method of claim 13, further comprising transmitting the latched data signal from the second I/O endpoint to the external memory to satisfy the write latency requirement.

15. The method of claim 12, wherein driving the command signal comprises driving a write command signal.

16. The method of claim 15, wherein driving the write command signal at the initial time is responsive to a first cycle of a clock signal.

17. The method of claim 12, further comprising changing the pipeline delay responsive to a change in the write latency requirement.

18. The method of claim 16, wherein changing the pipeline delay comprises controlling a plurality of multiplexers within the pipelined data bus.

19. An integrated circuit, comprising:
a memory controller;
first means for propagating a write command signal from the memory controller to a command and address (CA) endpoint without a pipeline delay; and
second means for propagating a write data (DQ) signal from the memory controller to a DQ endpoint with a pipeline delay, wherein the memory controller includes a third means for determining a delay difference period between a write latency period for an external memory and the pipeline delay and for driving the DQ signal into the means for propagating the DQ signal upon the expiration of the delay difference period.

20. The integrated circuit of claim 18, wherein the third means is configured to time the delay difference period responsive to cycles of a memory clock signal.

21. The integrated circuit of claim 18, wherein the second means is configured to propagate a plurality of DQ signals from the memory controller to a corresponding plurality of DQ endpoints with the pipeline delay.
